(19) United States
(12) Patent Application Publication
(10) Pub. No.: US 2010/0109966 A1
(43) Pub. Date: May 6, 2010

(54) Multi-Layer Miniature Antenna For Implantable Medical Devices and Method for Forming the Same

(76) Inventors: Duane N. Mateychuk, Ramsey, MN (US); Joyce K. Yamamoto, Maple Grove, MN (US); Gerard J. Hill, Champlin, MN (US); Charles S. Farlow, Eden Prairie, MN (US); Robert S. Wentink, Lino Lakes, MN (US); Michael William Barror, Gilbert, AZ (US); Charles R. Gordon, Phoenix, AZ (US); Joachim Hossick-Schott, Minneapolis, MN (US); Yanzhu Zhao, Blaine, MN (US)

Correspondence Address: Medtronic, Inc., 710 Medtronic Parkway, Mail Stop LC340, Minneapolis, MN, 55432, US

(21) Appl. No.: 12/347,597

(22) Filed: Dec. 31, 2008

Related U.S. Application Data
(60) Provisional application No. 61/110,536, filed on Oct. 31, 2008.

(51) Int. Cl. H01Q 1/38; H01Q 1/52; B05D 5/12

(52) U.S. Cl. 343/841; 343/700 MS; 427/2.24

(57) ABSTRACT

An antenna for an implantable medical device (IMD) is provided including a monolithic structure derived from a plurality of discrete dielectric layers having an antenna embedded within the monolithic structure. Superstrate dielectric layers formed above the antenna may provide improved matching gradient with the surrounding environment to mitigate energy reflection effects. A outermost biocompatible layer is positioned over the superstrates as an interface with the surrounding environment. A shielding layer is positioned under the antenna to provide electromagnetic shielding for the IMD circuitry. Substrate dielectric layers formed below the antenna may possess higher dielectric values to allow the distance between the antenna and ground shielding layer to be minimized. An electromagnetic bandgap layer may be positioned between the antenna and the shielding layer. The dielectric layers may comprise layers of ceramic material that can be co-fired together with the antenna to form a hermetically sealed monolithic antenna structure.

### RELATED APPLICATION

This application claims the benefit of and priority to U.S. Provisional Application Ser. No. 61/110,536, filed Oct. 31, 2008, entitled, “Multi-layer Miniature Antenna for Implantable Medical Devices and Method for Forming the Same,” the contents of which are incorporated by reference herein in its entirety.

### TECHNICAL FIELD

The present invention relates generally to implantable medical devices (IMDs) and, more particularly, the present invention relates to telemetry antennas suitable for deployment in IMDs.

### BACKGROUND

Various types of devices have been developed for implantation into the human body to provide various types of health-related therapies, diagnostics and/or monitoring. Examples of such devices, generally known as implantable medical devices (IMDs), include cardiac pacemakers, cardioverter/defibrillators, cardiomyostimulators, cardiac event monitors, various physiological stimulators including nerve, muscle, and deep brain stimulators, various types of physiological monitors and sensors, and drug delivery systems, just to name a few. IMDs typically include functional components contained within a hermetically sealed enclosure or housing, which is sometimes referred to as a “can.” In some IMDs, a connector header or connector block is attached to the housing, and the connector block facilitates interconnection with one or more elongated electrical medical leads. The header block is typically molded from a relatively hard, dielectric, non-conductive polymer. The header block includes a mounting surface that conforms to, and is mechanically affixed against, a mating sidewall surface of the housing.

It has become common to provide a communication link between the hermetically sealed electronic circuitry of the IMD and an external programmer, monitor, or other external medical device (“EMD”) in order to provide for downlink telemetry transmission of commands from the EMD to the IMD and to allow for uplink telemetry transmission of stored information and/or sensed physiological parameters from the IMD to the EMD, Conventionally, the communication link between the IMD and the EMD is realized by encoded radio frequency (“RF”) transmissions between an IMD telemetry antenna and transceiver and an EMD telemetry antenna and transceiver. Generally, the IMD antenna is disposed within the hermetically sealed housing. However, the typically conductive housing can limit the radiation efficiency of the IMD RF telemetry antenna, thereby traditionally limiting the data transfer distance between the programmer head and the IMD RF telemetry antenna to a few inches. This type of system may be referred to as a “near field” telemetry system. In order to provide for “far field” telemetry, or telemetry over distances of a few to many meters from an IMD or even greater distances, attempts have been made to provide antennas outside of the hermetically sealed housing and within the header block. Many of such attempts of positioning an RF telemetry antenna outside of the hermetically sealed housing and in the header block have utilized wire antennas or planar, serpentine antennas, such as the antennas described in U.S. Pat. No. 7,317,946, which is hereby incorporated by reference in its entirety. The volume associated with the antenna and header block conventionally required for the implementation of distance telemetry in implanted therapy and diagnostic devices has been a significant contributor to the size of the IMD.

### SUMMARY

In one or more embodiments, an antenna structure for an implantable medical device (IMD) is provided that includes at least one antenna conductor formed on a dielectric layer and a plurality of discrete dielectric layers positioned above the antenna conductor serving as superstrates and below the antenna conductor serving as substrates. In one or more embodiments, the superstrate dielectric layers include respective dielectric constants that gradually change in value with each superstrate layer moving away from the antenna conductor to values more closely matching the environment (e.g., body tissue) surrounding the antenna structure, such that the superstrate dielectric layers provide a matching gradient between the antenna conductor and the surrounding environment to mitigate energy reflection effects at the transition from the antenna structure to the surrounding environment.

In one or more embodiments, the antenna structure includes a biocompatible layer positioned as the outermost layer serving as an interface between the antenna structure and the surrounding environment, where the biocompatible layer may comprise one of the superstrate dielectric layers or another biocompatible layer positioned over the superstrate dielectric layers.

In one or more embodiments, the antenna structure includes a shielding layer formed from a metalized material positioned under the antenna conductor that provides electromagnetic shielding for device circuitry inside of a hermetically sealed housing to which the antenna structure is attached. In some embodiments, the shielding layer may be positioned under the substrate dielectric layers as the innermost layer of the antenna structure. In one or more embodiments, the substrate dielectric layers may include respective dielectric constants that gradually change in value with each substrate layer moving away from the antenna conductor to values more closely matching the hermetically sealed housing to the antenna structure is attached. In one or more embodiments, at least one of the substrate dielectric layers or another substrate layer may comprise an electromagnetic bandgap positioned between the antenna conductor and the shielding layer (i.e., ground plane) to prevent or minimize a reduction in antenna radiation efficiency from occurring as a result of effects from the ground plane shielding layer.

In one or more embodiments, the antenna structure may be formed as a monolithic structure derived from the plurality of discrete dielectric layers (superstrates and substrates) having an antenna conductor embedded within multiple layers of the plurality of dielectric layers. By forming a monolithic antenna structure derived from the plurality of dielectric layers, the dielectric constants of the plurality of dielectric layers can be selected or controlled to provide desired gradient matching and the dimensions of the overall antenna structure can be minimized to provide a miniature antenna structure.

In one or more embodiments, a plurality of different antenna conductor segments having different antenna characteristics may be embedded within the antenna structure, such that different antenna conductor segments or combinations of antenna conductor segments can be selected and/or switched for use in order to provide a tunable antenna to suit the needs of the particular IMD and/or the particular implant location. In some embodiments, a plurality of different antenna conductors may be formed on the same dielectric layer. In some embodiments, the antenna structure may include a plurality of discrete dielectric layers with at least one antenna conductor respectively positioned on each discrete dielectric layers with an outermost biocompatible layer and an innermost shielding (or grounding) layer, such that the effective dielectric between the antenna conductor and both the surrounding environment and the shielding/grounding plane can be switched to suit the needs of the particular IMD and/or the particular implant location.

In one or more embodiments, at least one of the plurality of dielectric layers used to form the antenna structure may include metamaterials to produce an effective permittivity and/or permeability having a negative value. The metamaterials may be epsilon-negative (ENG), mu-negative (MNG) or double negative (DNG). An antenna structure including at least one dielectric layer including metamaterials can be used to create effective permittivities and/or permeabilities that result in a desired impedance match condition for the metamaterial antenna structure having improved radiation efficiencies compared to similar antenna structures including natural double-positive (DPS) dielectric materials.

In one or more embodiments, the dielectric layers comprise at least one of a low temperature co-fire ceramic (LTCC) material and/or a high temperature co-fire ceramic (HTCC) material, where the ceramic dielectric layers, the antenna conductor(s), the biocompatible outermost layer, and the innermost shielding layer can be co-fired together to form a monolithic antenna structure.

### DRAWINGS

The above-mentioned features and objects of the present disclosure will become more apparent with reference to the following description taken in conjunction with the accompanying drawings wherein like reference numerals denote like elements and in which:

FIG. 1 illustrates an implantable medical device implanted in a human body in accordance with one or more embodiments of the present disclosure.

FIG. 2 is a schematic block diagram illustration of exemplary implantable medical device in accordance with one or more embodiments of the present disclosure.

FIG. 3 is a perspective, exploded view of an antenna structure for an implantable medical device formed in accordance with one or more embodiments of the present disclosure.

FIG. 4 is a cross-sectional side view of an antenna structure for an implantable medical device formed in accordance with one or more embodiments of the present disclosure.

FIG. 5 is a cross-sectional side view of a co-fired monolithic antenna structure for an implantable medical device formed in accordance with one or more embodiments of the present disclosure.

FIG. 6 is a schematic block diagram illustration of an antenna structure connected to implantable medical device in accordance with one or more embodiments of the present disclosure.

FIG. 7 is a perspective, exploded view of an antenna structure for an implantable medical device formed in accordance with one or more embodiments of the present disclosure.

FIG. 8 is a partial top view of a layer of an antenna structure for an implantable medical device formed in accordance with one or more embodiments of the present disclosure.

FIGS. 9A-9F are schematic illustrations of different antenna conductor configurations in accordance with one or more embodiments of the present disclosure.

FIG. 10 is an enlarged, partial cutaway, perspective view of an anodized antenna conductor in accordance with one or more embodiments of the present disclosure.

FIG. 11 is an exploded perspective view of an anodized antenna conductor having a superstrate radome in accordance with one or more embodiments of the present disclosure.

FIG. 12 is a cross-sectional side view of an antenna structure for an implantable medical device formed in accordance with one or more embodiments of the present disclosure.

### DETAILED DESCRIPTION

The following detailed description is merely illustrative and is not intended to limit the invention or the application and uses of the invention. Furthermore, there is no intention to be bound by any expressed or implied theory presented in the preceding technical field, background, brief summary or the following detailed description.

The following description refers to components or features being “connected” or “coupled” together. As used herein, unless expressly stated otherwise, “connected” means that one component/feature is directly or indirectly connected to another component/feature, and not necessarily mechanically. Likewise, unless expressly stated otherwise, “coupled” means that one component/feature is directly or indirectly coupled to another component/feature, and not necessarily mechanically. Thus, although the figures may depict example arrangements of elements, additional intervening elements, devices, features, or components may be present in an actual embodiment (assuming that the functionality of the IMDs are not adversely affected).

In one or more embodiments, an IMD having a monolithic antenna structure derived from a plurality of discrete dielectric layers is provided. For the sake of brevity, conventional techniques and aspects related to RF antenna design, IMD telemetry, RF data transmission, signaling, IMD operation, connectors for IMD leads, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

An IMD antenna generally has two functions: to convert the electromagnetic power of a downlink telemetry transmission of an EMD telemetry antenna propagated through the atmosphere (and then through body tissues) into a signal (e.g., a UHF signal or the like) that can be processed by the IMD transceiver into commands and data that are intelligible to the IMD electronic operating system; and to convert the uplink telemetry signals (e.g., a UHF signal or the like) of the IMD transceiver electronics into electromagnetic power propagated through the body tissue and the atmosphere so that the EMD telemetry antenna or antennas can receive the signals.

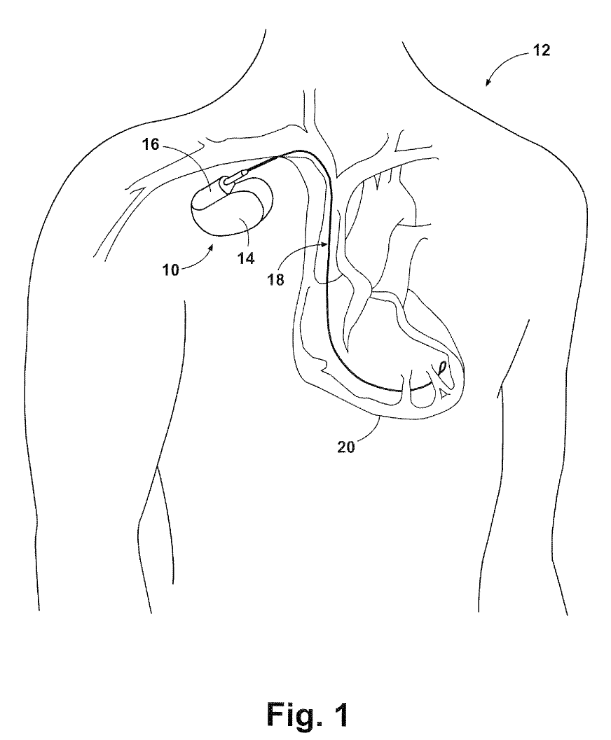

FIG. 1 is a perspective view of an IMD 10 implanted within a human body 12 in which one or more embodiments of the invention may be implemented. IMD 10 comprises a hermetically sealed housing 14 (or “can”) and connector header or block module 16 for coupling IMD 10 to electrical leads and other physiological sensors arranged within body 12, such as pacing and sensing leads 18 connected to portions of a heart 20 for delivery of pacing pulses to a patient's heart 20 and sensing of heart 20 conditions in a manner well known in the art. For example, such leads may enter at an end of header block 16 and be physically and electrically connected to conductive receptacles, terminals, or other conductive features located within header block 16. IMD 10 may be adapted to be implanted subcutaneously in the body of a patient such that it becomes encased within body tissue and fluids, which may include epidermal layers, subcutaneous fat layers, and/or muscle layers. While IMD 10 is depicted in FIG. 1 in an ICD configuration, it is understood that this is for purposes of illustration only and IMD 10 may comprise any type of medical device requiring a telemetry antenna.

In some embodiments, hermetically sealed housing 14 is generally circular, elliptical, prismatic, or rectilinear, with substantially planar major sides joined by perimeter sidewalls. Housing 14 is typically formed from pieces of a thin-walled biocompatible metal such as titanium. Two half sections of housing 14 may be laser seam welded together using conventional techniques to form a seam extending around the perimeter sidewalls. Housing 14 and header block 16 are often manufactured as two separate assemblies that are subsequently physically and electrically coupled together. Housing 14 may contain a number of functional elements, components, and features, including (without limitation): a battery; a high voltage capacitor; integrated circuit (“IC”) devices; a processor; memory elements; a therapy module or circuitry; an RF module or circuitry; and an antenna matching circuit. These components may be assembled in spacers and disposed within the interior cavity of housing 14 prior to seam welding of the housing halves. During the manufacturing process, electrical connections are established between components located within housing 14 and elements located within header block 16. For example, housing 14 and header block 16 may be suitably configured with IC connector pads, terminals, feedthrough elements, and other features for establishing electrical connections between the internal therapy module and the therapy lead connectors within header block 16 and for establishing connections between the internal RF module and a portion of a telemetry antenna located within header block 16. Structures and techniques for establishing such electrical (and physical) feedthrough connections are known to those skilled in the art and, therefore, will not be described in detail herein. For example, U.S. Pat. No. 6,414,835 describes a capacitive filtered feedthrough array for an implantable medical device, the contents of which are hereby incorporated by reference.

Header block 16 is preferably formed from a suitable dielectric material, such as a biocompatible synthetic polymer. In some embodiments, the dielectric material of header block 16 may be selected to enable the passage of RF energy that is either radiated or received by a telemetry antenna (not shown in FIG. 1) encapsulated within header block 16. The specific material for header block 16 may be chosen in response to the intended application of IMD 10, the electrical characteristics of the environment surrounding the implant location, the desired operating frequency range, the desired RF antenna range, and other practical considerations.

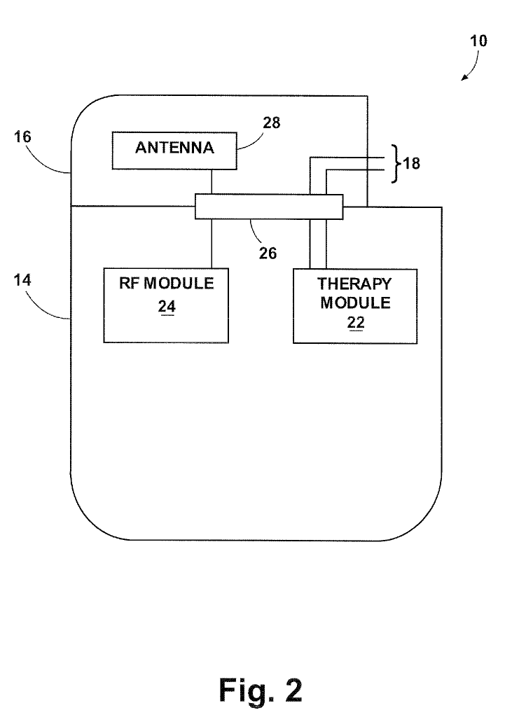

FIG. 2 is a simplified schematic representation of an IMD 10 and several functional elements associated therewith. IMD 10 generally includes hermetically sealed housing 14 and header block 16 coupled to housing 14, a therapy module 22 contained within housing 14, and an RF module 24 contained within housing 14. In practice, IMD 10 will also include a number of conventional components and features necessary to support the functionality of IMD 10 as known in the art. Such conventional elements will not be described herein.

Therapy module 22 may include any number of components, including, without limitation: electrical devices, ICs, microprocessors, controllers, memories, power supplies, and the like. Briefly, therapy module 22 is configured to provide the desired functionality associated with the IMD 10, e.g., defibrillation pulses, pacing stimulation, patient monitoring, or the like. In this regard, therapy module 22 may be coupled to one or more sensing or therapy leads 18. In practice, the connection ends of therapy leads 18 are inserted into header block 16, where they establish electrical contact with conductive elements coupled to therapy module 22. Therapy leads 18 may be inserted into suitably configured lead bores formed within header block 16. In the example embodiment, IMD 10 includes a feedthrough element 26 that bridges the transition between housing 14 and header block 16. Therapy leads 18 extend from header block 16 for routing and placement within the patient.

RF module 24 may include any number of components, including, without limitation: electrical devices, ICs, amplifiers, signal generators, a receiver and a transmitter (or a transceiver), modulators, microprocessors, controllers, memories, power supplies, and the like. RF module 24 may further include a matching circuit or a matching circuit may be positioned between RF module 24 and antenna 28. Matching circuit may include any number of components, including, without limitation: electrical components such as capacitors, resistors, or inductors; filters; baluns; tuning elements; varactors; limiter diodes; or the like, that are all suitably configured to provide impedance matching between antenna 28 and RF module 24, thus improving the efficiency of antenna 28. Briefly, RF module 24 supports RF telemetry communication for IMD 10, including, without limitation: generating RF transmit energy; providing RF transmit signals to antenna 28; processing RF telemetry signals received by antenna 28, and the like. In practice, RF module 24 may be designed to leverage the conductive material used for housing 14 as an RF ground plane (for some applications), and RF module 24 may be designed in accordance with the intended application of IMD 10, the electrical characteristics of the environment surrounding the implant location, the desired operating frequency range, the desired RF antenna range, and other practical considerations.

Antenna 28 is coupled to RF module 24 to facilitate RF telemetry between IMD 10 and an EMD (not shown). Generally, antenna 28 is suitably configured for RF operation (e.g., UHF or VHF operation, 401 to 406 MHz for the MICS/MEDS bands, 900 MHz/2.4 GHz and other ISM bands, etc.). In the example embodiment shown in FIG. 2, antenna 28 is located within header block 16 and outside of housing 14. However, the volume associated with the antenna 28 and the volume within the header block 16 required for the implementation of distance telemetry in implanted therapy and diagnostic devices can be a significant contributor to the size of the IMD 10. Antenna 28 may have characteristics resembling a monopole antenna, characteristics resembling a dipole antenna, characteristics resembling a coplanar waveguide antenna characteristics resembling a stripline antenna, characteristics resembling a microstrip antenna, and/or characteristics resembling a transmission line antenna. Antenna 28 may also have any number of radiating elements, which may be driven by any number of distinct RF signal sources. In this regard, antenna 28 may have a plurality of radiating elements configured to provide spatial, pattern, or polarization diversity

In one or more embodiments, antenna 28 is coupled to RF module 24 via an RF feedthrough in feedthrough 26, which bridges housing 14 and header block 16. Antenna 28 may include a connection end that is coupled to RF feedthrough in feedthrough 26 via a conductive terminal or feature located within header block 16. Briefly, a practical feedthrough 26 includes a ferrule supporting a non-conductive glass or ceramic insulator. The insulator supports and electrically isolates a feedthrough pin from the ferrule. During assembly of housing 14, the ferrule is welded to a suitably sized hole or opening formed in housing 14. RF module 24 is then electrically connected to the inner end of the feedthrough pin. The connection to the inner end of the feedthrough pin can be made by welding the inner end to a substrate pad, or by clipping the inner end to a cable or flex wire connector that extends to a substrate pad or connector. The outer end of the feedthrough pin serves as a connection point for antenna 28, or as a connection point for an internal connection socket, terminal, or feature that receives the connection end of antenna 28. The feedthrough 26 for antenna 28 may be located on any desired portion of housing 14 suitable for a particular design.

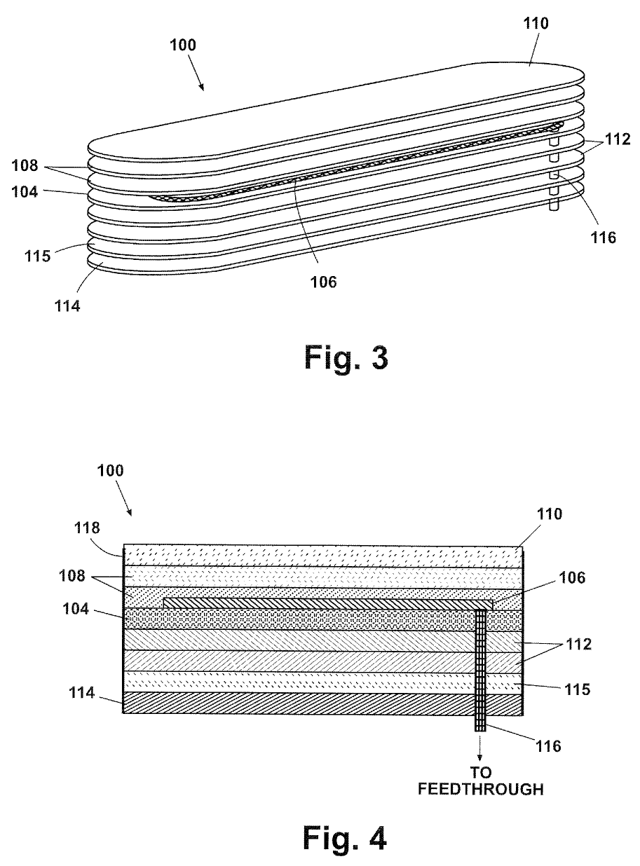

Referring now to FIG. 3, a perspective, exploded view of an antenna structure 100 formed in accordance with one or more embodiments is respectively illustrated. Certain features and aspects of antenna structure 100 are similar to those described above in connection with antenna 28, and shared features and aspects will not be redundantly described in the context of antenna structure 100. Antenna structure 100 includes at least one antenna conductor 106 formed on a dielectric layer 104. A plurality of discrete dielectric layers 108 are positioned above the antenna conductor 106 serving as superstrates, and a plurality of discrete dielectric layers 112 are positioned below the antenna conductor 106 serving as substrates. In one or more embodiments, the antenna structure 100 includes a biocompatible layer 110 positioned as the outermost layer over the superstrate dielectric layers 108 serving as an interface between the antenna structure 100 and the surrounding environment. In some embodiments, the biocompatible layer 110 may comprise the outermost of the superstrate dielectric layers 108. Different types of biocompatible materials can be selected based on the intended use of antenna structure 100 and IMD 10 and the intended surrounding environment. For example, outermost layer 110 may comprise inorganic materials, such as Alumina (Al₂O₃), zirconium oxide (ZrO₂), mixtures thereof, or bone-like systems [hydroxyapatite—Ca₅(POH)(PO₄)₃], organic materials, such as silicone and its derivatives, and other traditionally implantable biocompatible materials.

In one or more embodiments, antenna structure 100 may include an shielding layer 114 positioned in a layer under the antenna conductor 106 formed from a metalized material that provides electromagnetic shielding of device circuitry inside of the hermetically sealed housing 14 to which the antenna structure 100 is attached through a feedthrough via 116. In some embodiments, the shielding layer 114 is positioned as the innermost layer of the antenna structure 100, while it is understood that shielding layer 114 can also be positioned within another intermediate substrate layer 112 positioned under the antenna conductor 106.

In one or more embodiments, at least one of the substrate dielectric layers 112 or an electromagnetic bandgap layer 115 positioned under antenna conductor 106 may be selected from a material so as to function as an electromagnetic bandgap between antenna conductor 106 and shielding layer 114 (i.e., ground plane), as illustrated in FIG. 3 and further in the cross-sectional side view of antenna structure 100 in FIG. 4. Typically, when a radiating antenna element is placed above and in parallel with a ground plane, the field radiated by the antenna element and the field reflected by the ground plane are 180° out of phase due to the reflection coefficient presented by the ground plane short circuit. As a result, when the separation distance between the antenna element and the ground plane is reduced, the total antenna radiated fields tend to zero as the field radiated from the antenna element and its ground plane reflection will tend to completely cancel each other. An electromagnetic bandgap layer 115 prevents this reduction in antenna radiation efficiency by introducing a ground perturbation known as an electromagnetic bandgap, or high impedance surface, between antenna conductor 106 and ground plane shielding layer 114. The electromagnetic bandgap layer 115 prevents or minimizes a reduction in antenna radiation efficiency from occurring as a result of the close proximity of the antenna conductor 106 to the ground plane 114. In one aspect, the electromagnetic bandgap layer 115 at resonance appears as an open circuit with a reflection coefficient in phase with the incident field. For instance, the electromagnetic bandgap layer 115 will cause the field radiated from antenna conductor 106 and the field radiated by its ground plane image to be co-directed thus maintaining the same orientation and not canceling each other out. The electromagnetic bandgap layer 115 further provides a high electromagnetic surface impedance that allows the antenna conductor 106 to lie directly adjacent to the ground plane 114 without being shorted out. This allows compact antenna designs where radiating elements are confined to limited spaces Thus, the electromagnetic bandgap layer 115 assists in miniaturization of the device by allowing the distance between antenna conductor 106 and ground plane shielding layer 114 to be reduced to a small distance. In one or more embodiments, electromagnetic bandgap layer 115 may be vacuum deposited on the surface of one of the layers of the device 100 or adhered via epoxy after ceramic densification in order to minimize material alterations induced by thermal excursion of the firing process.

In one or more embodiments, the electromagnetic bandgap layer 115 may comprise a high impedance ground plane (e.g., artificial perfect magnetic conductor or PMC) that has the property of isolating the radiating elements from nearby electromagnetic surroundings. The high impendence surface of the electromagnetic bandgap layer 115 further provides the benefit of directing radiated energy away from ground plane shielding layer 114 and improves the antenna radiated front-to-back ratio resulting in improved antenna efficiency. In one or more embodiments, the electromagnetic bandgap layer 115 is made of a periodic structure, such as a plurality of discrete metal areas or a plurality of periodic lattice cells that are connected electrically to neighboring lattice cells, where such an interconnected bandgap structure topology conducts DC currents but not AC currents within a forbidden band. In one or more embodiments, the physical geometry the electromagnetic bandgap layer 115 may comprise a metal sheet, textured with a 2D lattice of resonant elements which act as a 2D filter to prevent the propagation of electric currents, such as described in the paper, “A High Impedance Ground Plane Applied to a Cellphone Handset Geometry,” by Sievenpiper et al., IEEE MTT Vol. 49 No. 7 July 2001 Pg 1262-1265, the contents of which are hereby incorporated by reference in its entirety.

In one or more embodiments, the electromagnetic bandgap layer 115 may comprise a reactive impedance substrate. PMC surfaces are usually constructed from resonant structures operating at resonance. By utilizing a reactive impedance substrate design, the adverse effects of the antenna interaction with the substrate are minimized such as the mutual coupling between the antenna conductor 106 and its image. The electromagnetic bandgap layer 115 can be engineered to exhibit normalized substrate impedance (image impedance) that could compensate for the stored energy in the source itself (antenna conductor 106). If the antenna conductor 106 shows a capacitive load and its image can store magnetic energy, a resonance can be achieved at a frequency much lower than the resonant frequency of the antenna conductor 106 in free space. An example of a reactive impedance substrate is set forth in the paper, “Antenna Miniaturization and Bandwidth Enhancement using a Reactive Impedance Substrate,” by Mosallaei et al, IEEE APS vol. 52 No. 9 September 2004 pg 2403-2414, the contents of which are hereby incorporated by reference in its entirety.

In one or more embodiments, at least one of the plurality of dielectric layers 104, 108, or 112 may be formed to include metamaterials to produce an effective permittivity and/or permeability having a negative value for the particular dielectric layers 104, 108, or 112 including the metamaterials. Metamaterials are artificial materials that exhibit electromagnetic properties that are not generally found in nature. For example, naturally occurring dielectric materials found in substrates are referred to as double-positive (DPS) as both epsilon (ε) and mu (μ) are positive. However, to the contrary, metamaterials may be epsilon-negative (ENG), mu-negative (MNG) or double negative (DNG) in which both epsilon and mu are negative. An antenna structure 100 including at least one dielectric layer 104, 108, or 112 including metamaterials can be used to create effective permittivities and/or permeabilities for antenna structure 100 that result in a desired impedance match condition for the antenna structure 100. Typically, electrically small antennas (i.e., those that are much shorter than a wavelength) are known to be very inefficient radiators as they possess a low resistive component and a large capacitive reactance component in their measure input impedance, thereby typically causing a poor impedance match condition. By using a metamaterial based antenna structure 100, the periodic inclusions in the metamaterial, which are located in the extreme near field of antenna conductor 106, can be adjusted to create effective permittivities and/or permeabilities that result in the desired impedance match condition for the antenna structure 100. This provides improved radiation efficiencies compared to similar antenna structures including natural double-positive (DPS) dielectric materials. For example, in some embodiments, an optimized metamaterial antenna structure 100 can demonstrate radiation efficiency improvements in excess of 35 dB when compared to the same antenna structure with natural DPS dielectric materials. An example of a metamaterial used formed using frequency selective surfaces (FSS) of gangbuster dipoles is set forth in the paper, “A Metamaterial Surface for Compact Cavity Resonators,” by Maci et al., IEEE AP Letters vol. 3 2004, pages 261-264, the contents of which are hereby incorporated by reference in its entirety. Further, metamaterial period cells include, 1-D Split-Ring Structure, Symmetrical-Ring Structure, Omega Structure, Unit S Cell Structure, as described in the paper, “A Study Using Metamaterials As Antenna Substrate To Enhance Gain,” by Grzegorczyk et al., PIER 51 2005, pages 295-328, the contents of which are hereby incorporated by reference in its entirety.

With further reference to the cross-sectional side view of antenna structure 100 illustrated in FIG. 4, in one or more embodiments, the edges 118 of the various layers of the antenna structure 100 (i.e., dielectric layers 104, 108 and 112, outermost biocompatible layer 110, electromagnetic bandgap layer 115, and shielding layer 114) may be brazed or otherwise sealed to hermetically seal the edges 118 of antenna structure 100 to a ferrule or body that would enable integration of antenna structure 100 to the housing 14. Generally, brazing involves melting and flowing a brazing material (e.g., a metal such as gold) around the portions of the desired surfaces to be brazed (e.g., the edges 118 of the layers of antenna structure 100 and housing 14).

In one or more embodiments, superstrate dielectric layers 108 can be selected to possess respective dielectric constants that gradually change in value with each superstrate layer 108 moving away from antenna conductor 106 to values more closely matching the dielectric constant of the environment (e.g., body tissue) surrounding the antenna structure 100. For instance, Alumina (Al₂O₃) has a dielectric constant k=9. In this manner, superstrate dielectric layers 108 provide a matching gradient between antenna conductor 106 and the surrounding environment to mitigate energy reflection effects at the transition from the antenna structure 100 to the surrounding environment. The change in dielectric constants in the various superstrate layers 108 can be achieved by incorporating materials that are cofireable, compatible and possess dielectric constants that differ from the other of the superstrate layers 108. In conventional antenna structures possessing abrupt transitions and differences in dielectric constants at the boundary between the antenna structures and the surrounding environment, there can be large energy reflection effects. The effects are reduced by the matching gradient provided by the superstrate dielectric layers 108, where the gradual change in dielectric values between the various superstrate dielectric layers 108 further helps to mitigate energy reflection effects between superstrate dielectric layers 108.

In one or more embodiments, various biocompatible layers formed for the superstrate dielectric layers 108 may comprise polymers that are loaded with high dielectric constant powders so as to produce an antenna structure 100 that contains a graded dielectric constant extending from one portion of the antenna structure 100 to another portion. For example, powders with different dielectric constants can be loaded on the different polymer layers, different concentrations of powder loading can be performed on the different polymer layers, or the dielectric constant of each polymer layer can otherwise have its powder loading adjusted to produce a structure having a graded dielectric constant between various superstrate dielectric layers 108. High dielectric loading may also modify the radio pattern of the antenna conductor 106 to reduce the power directly dissipated into the human body surrounding IMD 10.

In one or more embodiments, the substrate dielectric layers 112 under antenna conductor 106 may comprise materials with higher dielectric values than dielectric layer 104 on which antenna conductor 106 is formed, such that the higher dielectric values associated with substrate dielectric layers 112 allow the distance between antenna conductor 106 and ground plane shielding layer 114 to be minimized, thereby allowing a reduction in size of antenna structure 100 to be achieved. The high dielectric constant K of each layer may be achieved by incorporating cofireable materials having high dielectric constants K (e.g., capacitive materials). Depending upon the materials used to form substrate dielectric layers 112 and electromagnetic bandgap layer 115, dielectric constant values can vary anywhere from k=5-6 for the LTCC layer itself to at least 1-2 orders of magnitude higher with the use of capacitive pastes that are LTCC compatible. In addition, a ceramic loaded printed wiring board (PWB) is another embodiment to the LTCC based structure. LTCC materials offer the ability to embed passive components to spatially and functionally tailor the dielectric constant or capacitance to optimize packaging efficiency and/or performance. Since materials with high dielectric constants are typically not biocompatible, substrate dielectric layers 112 and electromagnetic bandgap layer 115 may be separated and isolated from potential contact with body environment surrounding IMD 10 by the biocompatible materials used to form outermost biocompatible layer 110 or other superstrate dielectric layers 108. The isolation of substrate layers 112 and electromagnetic bandgap layer 115 from the body environment surrounding IMD 10 allows the possible selection of materials for superstrate dielectric layers 108 to be wide ranging. For example, dielectric oxide (e.g., barium titanium oxide (BaTiO₃)) based systems with dielectric constants k in the hundreds to thousands are possible.

In one or more embodiments, the various layers used to form antenna structure 100 may be formed using any material layer deposition technique known in the art, including but not limited to depositing, spraying, screening, dipping, plating, etc. In some embodiments, molecular beam epitaxy (MBE), atomic layer deposition (ALD) or other thin film, vacuum deposited processes may be used to deposit the various layers building them on top of one another, such that ALD allows thin high dielectric materials to be used in forming substrate dielectric layers 112 and thin lower dielectric materials to be used in forming superstrate dielectric layers 108, thereby achieving size reduction and miniaturization of overall antenna structure 100 while still improving performing of antenna structure 100. The metal layers can be stacked to form a stacked plate capacitor structure to increase the dielectric constant of the area surrounding the antenna conductor 106.

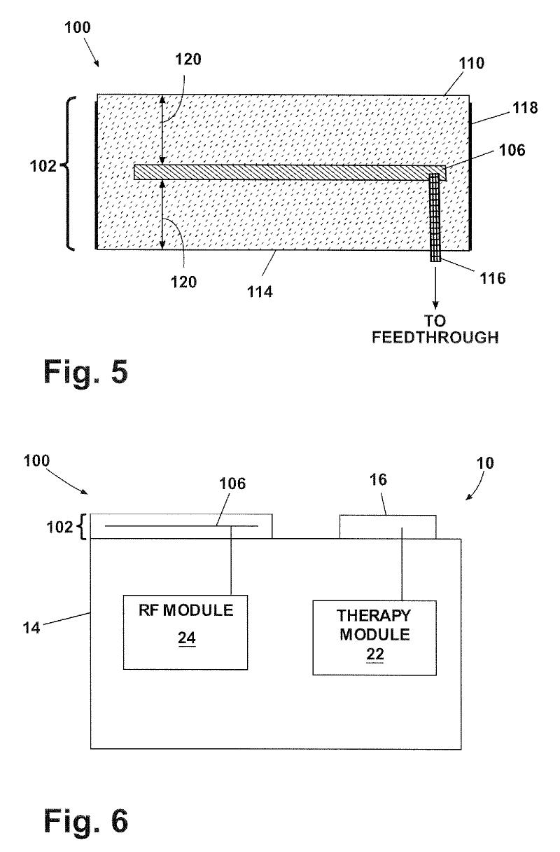

In one or more embodiments, after the various layers of antenna structure 100 and formed or otherwise deposited with respect to one another, as illustrated in FIG. 4, the various layers may be co-fired to a monolithic structure derived from the various layers, as illustrated in FIG. 5, having antenna conductor 106 embedded within the resulting monolithic structure 102. Feedthrough via 116 extends through monolithic structure 102 and may be used to connect antenna conductor 106 to housing 14, such as through a feedthrough. By forming a monolithic antenna structure 102 derived from the plurality of dielectric layers 104, 108 and 112, the dielectric constants of the plurality of dielectric layers 104, 108 and 112 can be selected or controlled to provide desired gradient matching and the dimensions of the overall antenna structure can be minimized to provide a miniature antenna structure. For example, in one or more embodiments, the plurality of dielectric layers 104, 108 and 112 can be selected such that they each possess gradually changing dielectric constants in the direction of arrows 120, such that the gradual changes can occur in either direction.

In one or more embodiments, at least one interlayer metal material having a high dielectric constant may be positioned at one or more locations between layers of high temperature co-fired ceramic (HTCC) material when forming the dielectric layers 104, 108 or 112 in order to increase the effective dielectric constant of such layers without requiring changes to the materials in forming such layers. In some embodiments, the metal interlayers can be patterned to provide the high dielectric values only where desired or needed, which can be useful in reducing cofire issues when the materials are cofired together. In some embodiments, the metal interlayers can be deposited through the use of vacuum deposition, ALD, screen printed thick film processes or other deposition techniques.

In one or more embodiments, after the antenna structure 100 has been formed as a co-fired monolithic structure 102, the edges 118 or side surfaces of the various layers of the antenna structure 100 (i.e., dielectric layers 104, 108 and 112, electromagnetic bandgap layer 115, outermost biocompatible layer 110 and innermost shielding layer 114) may be brazed or otherwise sealed to hermetically seal the edges 118 of antenna structure 100. The brazed side edges 118 along with the outermost biocompatible layer 110 of antenna structure 100 provide a hermetic seal for antenna structure 100 so that it can be connected directly to housing 14 without requiring a header to enclose and seal the antenna conductor 106, as typically required with conventional far field telemetry antennas for IMDs. As illustrated in FIG. 6, antenna structure 100 may be coupled to housing 14 using brazing, glassing, diffusion bonding or other suitable bonding techniques that will provide a hermetic seal, as known to those skilled in the art. The antenna structure 100 thus reduces the overall volume and physical dimension required for antenna conductor 106 for adequate radiation. In some embodiments, a header block 16 having reduced dimensions may still be utilized for connecting external leads to therapy module 16. In some embodiments, portions of the antenna structure 100 may be hermetically sealed to the housing 14 prior to overall formation of the co-fired monolithic structure 102, such that various layers used to form the co-fired monolithic structure 102 could be formed on one another after certain portions of the antenna structure 100 have been hermetically sealed to the housing 14.

In one or more embodiments, antenna conductor 106 is formed from a biocompatible conductive material, such as but not limited to at least one of the following materials: Platinum, Iridium, Platinum-Iridium alloys, Alumina, Silver, Gold, Palladium, Silver-Palladium or mixtures thereof, or Niobium, Molybdenum and/or Moly-manganese or other suitable materials. In one or more embodiments, dielectric layers 104, 108 and 112 may be comprise at least one of a ceramic material, a semiconductor material, and/or a thin film dielectric material. In some embodiments in which the dielectric layers 104 include at least one ceramic material, the dielectric layers 104, 108 and 112 may include at least one of a low temperature co-fired ceramic (LTCC) material or a high temperature co-fired ceramic (HTCC) material or a PWB material that enable the incorporation of materials having desired dielectric constant values. Generally, a LTCC material has a melting point between about 850° C. and 1150°C., while a HTCC material has a melting point between about 1100° C. and 1700° C. The ceramic dielectric layers 104, 108 and 112, antenna conductor 106, electromagnetic bandgap layer 115, outermost biocompatible layer 110 and innermost shielding layer 114 and via 116 are sintered or co-fired together to form a monolithic antenna structure 102 including an embedded antenna conductor 106, as illustrated in FIG. 5. Methods for co-firing layers of ceramic materials together to form monolithic structures for use in IMDs are described, for example, in U.S. Pat. No. 6,414,835 and U.S. Pat. No. 7,164,572, the contents of both of which are hereby incorporated by reference in their entireties.

According to one or more embodiments, the use of a co-firing technique to form a monolithic antenna structure 102 including an embedded antenna 106 allows for the manufacture of low-cost, miniaturized, hermetically sealed antenna structures 100 suitable for implantation within tissue and/or in direct or indirect contact with diverse body fluids. The monolithic antenna structure 102 can be hermetically connected directly to a portion of housing 14 of an IMD 10 or alternatively sealed within a header block 16.

In one or more embodiments, the plurality of different individual discrete layers or sheets of materials (or segments of tape) that comprise the various ceramic dielectric layers 104, 108 and 112, antenna conductor 106, electromagnetic bandgap layer 115, outermost biocompatible layer 110 and innermost shielding layer 114 may be printed with a metalized paste and other circuit patterns, stacked on each other, laminated together and subjected to a predetermined temperature and pressure regimen, and then fired at an elevated temperature(s) during which the majority of binder material(s) (present in the ceramic) and solvent(s) (present in the metalized paste) vaporizes and/or is incinerated while the remaining material fuses or sinters. The number of dielectric layers 104, 108 and 112 may be variably selected based on the desired antenna characteristics. In some embodiments, the materials suitable for use as cofireable conductors for forming the antenna conductor 106 are the biocompatible metal materials described herein or other materials suitable for the metalized paste. In one or more embodiments, the stacked laminates are then co-fired together at temperatures between about 850° C. and 1150° C. for LTCC materials and between about 1100° C. and 1700° C. for HTCC materials.

In one or more embodiments, the dielectric layers 104, 108 and 112 include a plurality of planar ceramic layers. Each ceramic layer may be shaped in a green state to have a desired layer thickness. In general, the formation of planar ceramic layers starts with a ceramic slurry formed by mixing a ceramic particulate, a thermoplastic polymer and solvents. This slurry is spread into ceramic sheets of predetermined thickness, from which the solvents are volitized, leaving self-supporting flexible green sheets. Holes in certain dielectric layers 104 and 112 that will be filled with conductive material to form via 116 are made, using any conventional technique, such as drilling, punching, laser cutting, etc., through the green sheets from which the ceramic layers 104 and 112 are formed. The materials suitable for use as cofireable ceramics include alumina (Al₂O₃), aluminum nitride, beryllium oxide, Silica (SiO₂), Zirconia (ZrO₂), glass-ceramic materials, glass suspended in an organic (polymer) binder, or mixtures thereof.

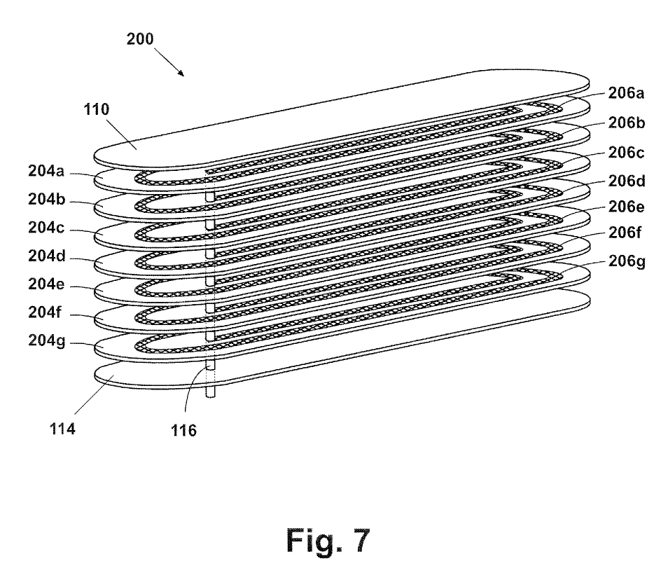

Referring now to FIG. 7, a perspective, exploded view of an antenna structure 200 formed in accordance with one or more embodiments is illustrated in which a plurality of different antenna conductors 206a-206g having different antenna characteristics may be embedded within antenna structure 200. Certain features and aspects of antenna structure 200 are similar to those described above in connection with antenna 100, and shared features and aspects will not be redundantly described in the context of antenna structure 200. Antenna structure 200 may include a plurality of discrete dielectric layers 204a-204g with at least one antenna conductor 206 respectively positioned on each discrete dielectric layer 204. An outermost biocompatible layer 110 and an innermost ground shielding layer 114 are respectively arranged as the upper and lower surfaces of antenna structure 200. Each of the antenna conductors 206a-206g may possess the same antenna configuration or different antenna configurations from the other antenna conductors 206a-206g arranged on different dielectric layers 204a-204g. Further, each of the dielectric layers 204a-204g may have the same or different dielectric values from the other dielectric layers 204a-204g. At least one switch is provided in order to allow different respective antenna conductors 206a-206g to be selectively switched in or out based the desired operating characteristics for antenna structure 100. In this manner, antenna structure 100 can adapt to provide a specific desired radiation polarization, such that antenna structure 200 can be controlled to provide x-polarized, y-polarized and/or even circular polarizations with the simple toggling of switches to reconfigure antenna structure 200 to provide the desired performance. Similarly, antenna conductors 206a-206g may be selectively switched in or out to provide a specific desired radiation pattern. In this manner, the structure can be adapted to provide directivity so as to optimize the reception of a signal from a specific EMD or, alternatively, to optimize the transmission of a signal to a specific EMD. In one or more embodiments, MEMS switches may be utilized and located on respective layers of antenna structure 200 in order to maintain the miniaturization of antenna structure 100. Antenna structure 200 is thus able to change frequencies by selectively switching the particular antenna conductors 206a-206g to utilize in order to increase or decrease the resultant antenna length. In some embodiments, multiple ones of antenna conductors 206a-206g may be switched to be connected and used together (e.g., through vias interconnecting antenna conductors 206a-206g). Further, the effective dielectric between the selected antenna conductor 206a-206g and both the surrounding environment and the ground shielding layer 114 can be switched to suit the needs of the particular IMD 10 and/or the particular implant location.

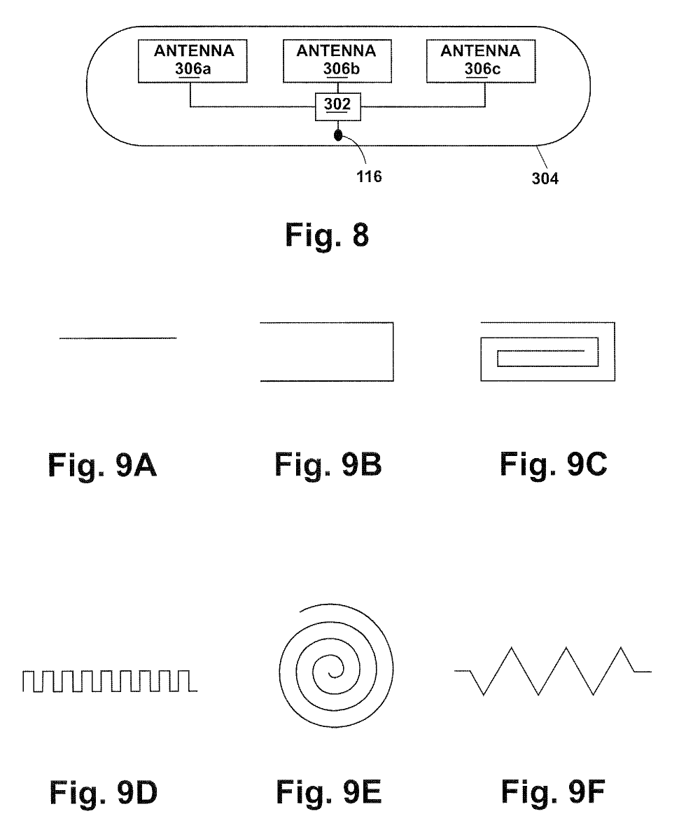

Referring now to FIG. 8, in one or more embodiments, a plurality of different antenna conductors 306a-306c may be formed on the same dielectric layer 304, as illustrated by the partial schematic illustrate of a single dielectric layer 304 of antenna 100. Certain features and aspects of dielectric layer 304 and antenna conductors 306a-306c are similar to those described above in connection with dielectric layer 104 and antenna conductor 106, and shared features and aspects will not be redundantly described in the context of dielectric layer 304 and antenna conductors 306a-306c. A switch 302 may interconnect antenna conductors 306a-306c to via 116, such that particular antenna conductors 306a-306c may be selectively switched to be used to reconfigure antenna structure 200 to provide the desired performance (e.g., desired antenna length, desired radiation polarization, desired radiation pattern, to account for particular IMD 10, particular implant location, and/or particular EMD location, etc.). Each of the antenna conductors 306a-306c may possess the same or different antenna configurations as the other antenna conductors 306a-306c. In some embodiments, multiple antenna conductors 306a-306c on the same dielectric layer 304 may be connected and used together. In some embodiments, a plurality of different antenna conductors 306a-306c may be formed on a plurality of different dielectric layers, such as illustrated in FIG. 7, where specific dielectric layers may be selected and specific antenna conductors 306a-306c on a selected dielectric layer may be selected based on the desired antenna characteristics.

Referring now to FIGS. 9A-9F, multiple different possible types of antenna arrangements for any of the antenna conductors 106, 206a-206g, 306a-306c are illustrated in accordance with one or more embodiments.

The use of a multi-layer ceramic antenna structure 100 comprised of co-fired materials provide for reduced antenna volume, increased device density and functionality, and the ability to provide embedded antenna functionality, all in a hermetically-sealed monolithic antenna structure 102. For example, in one embodiment, a multi-layer ceramic antenna structure 100 having structural dimensions of 50 mm×12.5 mm×1.0 mm can be produced, while in another embodiment, a multi-layer ceramic antenna structure 100 having structural dimensions of 20 mm×5 mm×0.4 mm can be produced.

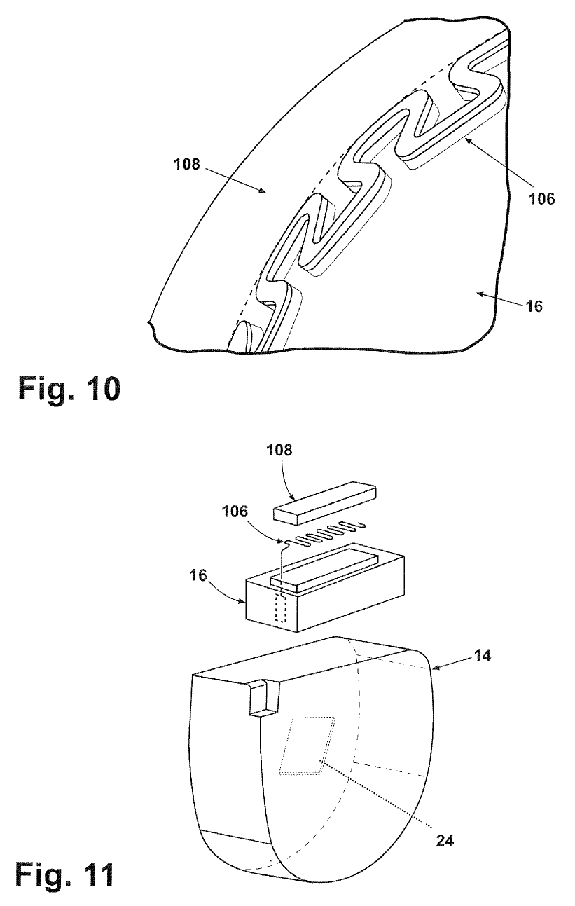

In one or more embodiments, rather than forming a monolothic, multi-layer ceramic antenna structure 100 comprised of co-fired materials, the antenna conductor 106 may simply be coated with a high dielectric constant superstrate 108 coating, as illustrated in FIG. 10. The superstrate coating 108 may comprise one or more coatings of high dielectric constant material that are formed on the antenna conductor 106 by an anodization process. Anodization processes tend to be low in cost and highly reliable. It is also possible to deposit or form the high dielectric constant superstrate 108 coating on the antenna conductor 106 using other deposition techniques known to those skilled in the art. In this manner, an anodized antenna conductor 106 having a high dielectric constant superstrate coating 108 is provided. Coating the antenna conductor 106 with the high dielectric constant superstrate 108 provides a simple manner of improving antenna performance with a minimal change to existing device configurations while providing a matching gradient of dielectric constant between the antenna conductor 106 and the surrounding environment. The matching gradient reinforces the energy transition from the header 16 (e.g., ε=4) to the surrounding environment (e.g., ε=80) using the high dielectric constant superstrate 108 (e.g., ε≈10≈80). High dielectric loading may also modify the radiation pattern to reduce the power directly dissipated into the human body. In one or more embodiments, the high dielectric constant superstrate 108 coating may comprise silicone doped with high dielectric constant materials, such as titanium dioxide or barium strontium titanate (BST).

In accordance with one or more embodiments, the antenna conductor 106 (either anodized as described with reference to FIG. 10 or non-anodized) may further be situated within the header 16 such that the superstrates 108 are formed as an antenna radome having a controlled dielectric gradient that encloses the antenna conductor 106 within the header 16, as illustrated in the exploded perspective view of FIG. 11. In other embodiments, the superstrates 108 may simply be formed within the header 16 between the antenna conductor 106 and a surface of the header 16.

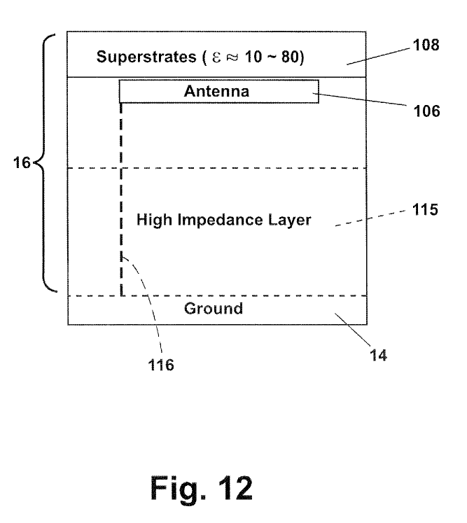

In one or more of the embodiments described with reference to FIGS. 10 and 11, a layer of high electromagnetic impedance material (e.g., similar to electromagnetic bandgap layer 115) may be positioned below the antenna conductor 106 capable of suppressing the propagation of surface current in the ground (e.g., housing 14), thereby isolating the radiating elements from the nearby surroundings in order to further improve the radiation efficiency of the antenna conductor 106, as illustrated in FIG. 12.

In one or more embodiments, when a multi-layer ceramic antenna structure 100 is formed from the various layers described herein in connection with FIGS. 1-9, one or more of the layers of the multi-layer ceramic antenna structure 100 may be patterned to possess a desired shape with respect to the antenna conductor 106. For example, one or more of the layers of the multi-layer ceramic antenna structure 100 could be patterned to possess a substantially similar shape as the antenna conductor 106 such that the multi-layer ceramic antenna structure 100 could be formed as described herein in connection with FIGS. 1-9 while having an overall shape that substantially mimics the shape of the antenna conductor 106 (e.g., such as the shape illustrated in FIG. 10). In other embodiments, some of the layers (e.g., superstrate layers 108) of the multi-layer ceramic antenna structure 100 may be patterned to mimic the shape of the antenna conductor 106 while other layers in the multi-layer ceramic antenna structure 100 may be formed having different shapes. In still further embodiments, the various layers of the multi-layer ceramic antenna structure 100 could be patterned to possess other shapes to provide desired operational characteristics for the multi-layer ceramic antenna structure 100.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. An antenna for an implantable medical device (“IMD”), comprising:
a structure derived from a plurality of discrete dielectric layers; and
an antenna conductor embedded within the structure within the plurality of dielectric layers,
wherein the structure is derived from a plurality of the dielectric layers being formed over the antenna conductor as superstrates that include gradually changing dielectric values as the dielectric layers move away from the antenna conductor to provide a matching gradient between the antenna conductor and an environment surrounding the antenna.

2. The antenna of claim 1, further comprising an outermost layer of biocompatible material formed over the superstrate dielectric layers.

3. The antenna of claim 1, further comprising a shielding layer positioned under the antenna conductor for providing electromagnetic shielding between the antenna conductor and the IMD to which the antenna is connected.

4. The antenna of claim 3, further comprising a layer of electromagnetic bandgap material positioned between the antenna conductor and the shielding layer.

5. The antenna of claim 1, wherein the structure is partially derived from a plurality of the dielectric layers being formed under the antenna conductor as substrates of high dielectric materials that allow the distance between the antenna conductor and the shielding layer to be minimized.

6. The antenna of claim 1, wherein at least one of the plurality of dielectric layers includes metamaterials to produce a negative effective permittivity or permeability for such at least one dielectric layer including the metamaterials.

7. The antenna of claim 1, further comprising:
at least one additional antenna conductor embedded within the structure; and
a switching device operatively connected to each of the antenna conductors for allowing desired ones of the antenna conductors to be selected for use in the antenna.

8. The antenna of claim 7, further comprising a plurality of antenna conductors embedded within the structure with each antenna conductor being formed on a separate respective dielectric layer.

9. The antenna of claim 7, further comprising a plurality of antenna conductors embedded within the structure with each antenna conductor being formed on the same dielectric layer.

10. The antenna of claim 1, wherein at least one of the dielectric layers comprises a ceramic material.

11. The antenna of claim 10, wherein the dielectric layers and the antenna conductor are part of a monolithic structure that has been co-fired together.

12. The antenna of claim 1, wherein at least one of the dielectric layers comprises a low temperature co-fire ceramic (LTCC) material having a melting point between about 850° C. and 1150° C. and a cofireable paste having a high dielectric constant.

13. The antenna of claim 1, wherein at least one of the dielectric layers comprises a high temperature co-fire ceramic (HTCC) material having a melting point between about 1100° C. and 1700° C.

14. The antenna of claim 1, wherein the antenna conductor is formed from a biocompatible conductive material.

15. A method for fabricating an antenna for an implantable medical device (“IMD”), comprising:
depositing a biocompatible conductive material over a dielectric layer;
depositing a plurality of discrete dielectric layers over the biocompatible conductive material, wherein the dielectric layers are formed over the biocompatible conductive material as superstrates that include gradually changing dielectric values as the dielectric layers move away from the biocompatible conductive material to provide a matching gradient between the antenna conductor and an environment surrounding the antenna; and
co-firing the dielectric layers and biocompatible conductive material together into a monolithic structure, wherein the biocompatible conductive material resulting in the co-fired monolithic structure serves as an antenna conductor.

16. The method of claim 15, further comprising depositing an outermost layer of biocompatible material over the superstrate dielectric layers prior to co-firing the layers together.

17. The method of claim 15, further comprising depositing a shielding layer of a metalized material as a layer under the antenna conductor biocompatible conductive material for providing electromagnetic shielding between the antenna conductor and the IMD to which the antenna is to be connected.

18. The method of claim 17, further comprising depositing a layer of electromagnetic bandgap material between the antenna conductor biocompatible conductive material and the shielding layer prior to co-firing the layers together.

19. The method of claim 17, further comprising depositing a plurality of the dielectric layers that are formed under the antenna conductor biocompatible conductive material and serve as substrates of high dielectric materials that allow the distance between the antenna conductor biocompatible conductive material and the shielding layer to be minimized.

20. The method of claim 15, further comprising forming at least one of the plurality of dielectric layers to metamaterials to produce a negative effective permittivity or permeability for such at least one dielectric layer including the metamaterials.

21. The method of claim 15, further comprising:
depositing the biocompatible conductive material over different portions of a dielectric layer to form different antenna conductors on the same dielectric layer prior to co-firing the layers together;
operatively connecting a switching device to each of the antenna conductors for allowing desired ones of the antenna conductors to be selectable for use in the antenna.

22. The method of claim 15, further comprising:
depositing the biocompatible conductive material over different respective dielectric layers to form different antenna conductors on a plurality of dielectric layers prior to co-firing the layers together;
operatively connecting a switching device to each of the antenna conductors for allowing desired ones of the antenna conductors to be selectable for use in the antenna.

23. The method of claim 15, wherein at least one of the dielectric layers comprises a ceramic material.

24. The method of claim 23, wherein at least one of the dielectric layers comprises a low temperature co-fire ceramic (LTCC) material having a melting point between about 850° C. and 1150° C., the method further comprising co-firing the layers together at a temperature between about 850° C. and 1150° C.

25. The method of claim 23, wherein at least one of the dielectric layers comprises a high temperature co-fire ceramic (HTCC) material having a melting point between about 1100° C. and 1700° C., the method further comprising co-firing the layers together at a temperature between about 1100° C. and 1700° C.

26. An antenna for an implantable medical device (“IMD”), comprising:
an antenna conductor, and
a superstrate material positioned over the antenna conductor having a gradually changing dielectric value to provide a matching gradient between the antenna conductor and an environment surrounding the antenna in a radiating direction for the antenna.

27. The antenna of claim 26, wherein the superstrate material is formed on the antenna conductor by an anodization process.

28. The antenna of claim 26, wherein the superstrate material is derived from a plurality of the dielectric layers being formed over the antenna conductor as superstrates that include gradually changing dielectric values as the dielectric layers move away from the antenna conductor.

29. The antenna of claim 26, further comprising a high impedance layer positioned between the antenna conductor and a grounding surface.
